(19) United States
(12) Patent Application Publication
(10) Pub. No.: US 2023/0064041 A1
(43) Pub. Date: Mar. 2, 2023

(54) SYSTEMS AND METHODS FOR IMPROVING EFFICIENCY IN CONTINUING EDUCATION MANAGEMENT

(71) Applicant: My MOC Inc. d/b/a Mocingbird, North Kingstown, RI (US)

(72) Inventors: Sanjeeka Jayakody Silva, Woburn, MA (US); George Fernaine, New York, NY (US); Ian Anthony Madom, Wakefield, RI (US); Ankur Kirit Kapadia, Northridge, CA (US); Brad Lee Artery, North Kingstown, RI (US); Ratnadeep Ramchandra Deshmane, Maharashtra (IN)

(21) Appl. No.: 17/823,347

(22) Filed: Aug. 30, 2022

Related U.S. Application Data
(60) Provisional application No. 63/238,563, filed on Aug. 30, 2021.

(51) Int. Cl. G06Q 50/20

(52) U.S. Cl. CPC G06Q 50/2057

(57) ABSTRACT

Systems and methods for improving efficiency in continuing education management may include a cloud-based continuing education (CE) management platform customized for the user to streamline end-to-end CE management. The system may accept license and certification information from the end user and utilize a rules engine and a CE content library database to generate a task-driven dashboard with personalized CE content recommendations as output for the end user. The systems and methods may include the conversion of a regulation into a standardized task component structure that may enable task generation with specific due dates and credit calculations. The systems may include an additional layer of metadata created for each element of CE content in the system to identify course relevance to a rules task via keywords.

### CROSS-REFERENCES TO RELATED APPLICATIONS

This non-provisional patent application claims priority to U.S. Provisional Patent Application No. 63/238,563, filed Aug. 30, 2021, entitled SYSTEMS AND METHODS FOR IMPROVING EFFICIENCY IN CONTINUING EDUCATION MANAGEMENT, which is hereby incorporated by reference in its entirety.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### TECHNICAL FIELD

The present disclosure generally relates to computing systems that calculate compliance in continuing education management and more particularly to the methods and systems for a customized continuing education rules and requirements tracking dashboard with personalized course recommendations.

### BACKGROUND

Healthcare providers (including physicians, nurse practitioners, and physician assistants) must either hold a national board certification or a state issued license in order to practice medicine in the United States. Such certifications/licenses must be periodically renewed. Maintenance and renewal of such certifications and licenses often involve a healthcare provider meeting various continuing education (CE) requirements. Healthcare providers face several technical challenges in meeting these requirements.

First, the healthcare provider must comply with multiple requirements set forth by multiple entities. The CE rules and regulations vary at the state, board, and institution level as they pertain to: (1) renewal cadences, timelines, dates, (2) sources and types of CE content, and (3) number, type, and accreditation of credits required. The education requirements also often change as new legislation is passed to address newer challenges and as diseases become more prevalent. As a healthcare provider obtains multiple certifications and licenses, the complexity of tracking CE requirements can increase exponentially.

Second, the multiple requirements often have asynchronous timelines. For example, a state license may have an annual renewal deadline, but a board certification may have a biannual renewal deadline. Additionally, such deadlines may fall on different days of the year. Renewal dates are constantly changing and evolving.

Third, searching for CE courses that meet the requirements becomes very time consuming. These efforts take away from the healthcare provider's time with patients.

Fourth, there is a severe lack of control and data completeness when it comes to meeting the requirements. Entities charged with administering the certifications and licenses often do not send out reminders and provide little guidance as to what activities and courses meeting certain requirements.

Lastly, with the rise of telehealth, some providers have the need to obtain licenses from multiple jurisdictions. For example, in the United States, some medical providers need to obtain licenses for all 50 states and territories such as Guam and Virgin Islands.

Existing computer systems that provide CE management have several technical limitations. First, the conventional computer systems offer little or no customization to the user. Instead, these conventions systems simply offer static web pages listing license requirements or courses that may offer credit toward complying with such requirements. Second, conventional systems are unable to determine whether certain CE courses will assist a user in complying with requirements. As such, conventional systems cannot calculate whether a certain CE course is relevant to the user or whether the CE course will assist the user in fulfilling licensing requirements.

Other limitations that conventional systems have include (1) simply listing the license or certification expiration date, as opposed to when specific CE requirements for the license/certification are due, (2) containing a generic list of the CE requirements with no specific due dates, which vary based on various provider information such as the initial license date, birth date, specialization etc., (3) providing a bundle of courses that meet CE for a certain state license without any customization or a way to track completion of the course fulfillment against requirements, or (4) having requirements tracking and course availability with very limited scope such as a single state, which does not maximize CE applicability across licenses. The chances of providers making errors when determining whether they are taking a course that works towards compliance or whether the providers have complied with all requirements is high.

As such, there is a clear need for a centralized system that provides licensed professionals a customized, efficient way to manage CE requirements across multiple licenses and certifications with personalized recommendations on CE content to fulfill those requirements in a timely manner.

### SUMMARY

One aspect of the present disclosure generally relates to a system that aggregates rules and regulations into a database, uses algorithms with custom logic to determine information about the rules and regulations, and presents results of the determination as data to an end user on a web or mobile device as a personalized dashboard. This aspect may relate to a novel application of a comprehensive automated continuing education (CE) management system with an intuitive user interface.

The present disclosure, in one embodiment, may include a computer-implemented system and method for improving the efficiency of the end-to-end CE management process for licensed professionals. One aspect of the disclosure relates to streamlining the rules and regulation data capture and storage into a standardized component structure and building a rules engine module that utilizes this proprietary data library and system logic to generate the task-driven user dashboard. The component structure of this aspect may include the following for a task: name, due date, cyclic nature, credit type and count, keywords for course mapping, user interface (UI) fields/flags for license onboarding, UI fields/flags for CE categorization, and logic (e.g., related to credit calculation & task generation).

Another aspect of the disclosure may connect these tasks on a user's dashboard with the CE content library on the system to generate personalized course recommendations to fulfill these tasks. In one embodiment, an aspect of the disclosure may include capturing data on the user's personal preferences for CE content such as: (1) price—free vs. paid, (2) value—number of credits per price, (3) length of content, (4) content provider, (5) content type (e.g., course, conference, podcast, bundled packages, etc.), (6) practicing specialty relevance, or (7) peer review rating. Another aspect may include capturing one or more areas of interest important to a healthcare system, such as value based purchasing metrics or factors impacting patient experience. Another aspect may include integrating relevant patient related information for the user directly from an electronic medical record system or other system that may capture one or more types of patients and procedures commonly seen by the user in order to curate the one or more relevant or useful courses for the user. The systems and methods of the disclosure may include capturing and adding a layer of metadata to at least a portion of the CE content in the library, including but not limited to, tagging the state rules relevance/mandate information and keywords that capture course subject matter such as “pain management,” “infection disease,” etc.

One embodiment of the systems and methods of the present disclosure may include systematically capturing and algorithmically connecting the data on three fronts: (1) the rules engine module, (2) the CE content library with the added metadata layer, and (3) user preferences or health system needs to create custom output that simplifies the CE management for the end user. The output generated by the system may not only make personalized CE content recommendations at the individual task level but, additionally or alternatively, may look at all the tasks across licenses and certifications to make global CE content recommendations that maximize the fulfillment of the number of tasks with the minimum number of course/content consumption.

One aspect of the disclosure includes a computer-implemented method. The method may include receiving, over a data network and from a user interface, license and certification information inputs. The license and certification information inputs may be associated with a user. The license and certification information inputs may include a medical license or certification of the user. The method may include generating, at a rules engine stored in a computer memory of a server, a plurality of task data objects for the user. Each task data object of the plurality of task data objects may include a name and a due date, and an amount of credits. The method may include selecting, from a data storage that stores a continuing education (CE) content library, a plurality of CE content data objects based on the plurality of task data objects and metadata associated with the CE content data objects. The method may include digitally connecting each CE content data object of the plurality of CE content data objects with at least one task data object of the plurality of task data objects. The method may include presenting, via a second user interface, a task-driven dashboard to the user. The dashboard may include a visual representation of the plurality of task data objects, and the plurality of the CE content data objects.

Another aspect of the disclosure includes a system. The system may include a non-transitory computer-readable storage medium having executable instructions stored thereon, wherein the executable instructions, when executable by a processor, cause the processor to perform various steps. The steps may include receiving, over a data network and from a user interface, license and certification information inputs. The license and certification information inputs may include a medical license or certification of the user. The steps may include generating, at a rules engine stored in a computer memory of a server, a plurality of task data objects for the user. Each task data object of the plurality of task data objects may include a name and a due date, and an amount of credits. The steps may include selecting, from a data storage that stores a continuing education (CE) content library, a plurality of CE content data objects based on the plurality of task data objects and metadata associated with the CE content data objects. The steps may include digitally connecting each CE content data object of the plurality of CE content data objects with at least one task data object of the plurality of task data objects. The steps may include presenting, via a second user interface, a task-driven dashboard to the user. The dashboard may include a visual representation of the plurality of task data objects, and for each task data object in the plurality of task data objects, at least one CE content data object of the plurality of the CE content data objects.

Another aspect of the disclosure includes a system. The system may include a server. The server may include a rules engine module, a course recommendation module, and a compliance module. The system may include a data storage module, which may include a file storage and a database. The rules engine module may be configured to receive, over a data network and from a user interface, license and certification information inputs. The license and certification information inputs may include a medical license or certification of the user. The rules engine module may generate a plurality of task data objects for the user. Each task data object of the plurality of task data objects may include a name and a due date, and an amount of credits. The course recommendation module may be configured to select, from the database that stores a continuing education (CE) content library, a plurality of CE content data objects based on the plurality of task data objects and metadata associated with the CE content data objects. The course recommendation module may digitally connect each CE content data object of the plurality of CE content data objects with at least one task data object of the plurality of task data objects. The course recommendation module may present, via a second user interface, a task-driven dashboard to the user. The dashboard may include a visual representation of the plurality of task data objects, and the plurality of the CE content data objects. The compliance module may be configured to receive a task completion evidence file from the user, store the file in the file storage, extract metadata from the file, calculate a credit amount based on the metadata, and apply the credit amount to a task data object of the plurality of task data objects.

It is understood that both the foregoing general description and the following detailed description are exemplary and exemplary only and are not restrictive of the disclosure as claimed.

### BRIEF DESCRIPTION OF THE DRAWINGS

The accompanying drawings, which are incorporated in and constitute a part of the specification, illustrate exemplary embodiments of the disclosure. Together with the description, they serve to explain the objects, advantages, and principles of the disclosure.

FIG. 1 is a block diagram of one embodiment of a system architecture of the present disclosure.

FIG. 2A is a flowchart of one embodiment of a method of improving efficiency in continuing education management.

FIG. 2B is a flowchart of one embodiment of a method of user interaction with a system of the present disclosure.

FIG. 3 is a screenshot of one embodiment of a web application user interface illustrating a user data entry for an example state license.

FIG. 4 is one embodiment of a list of one or more components of a rule set of an example rules engine module of the present disclosure.

FIG. 5A is one embodiment of an example of a rules data capture, referred to as a rules specification process, which may include one or more elements of the rules engine module.

FIG. 5B is a continuation of the example rules data capture of FIG. 5A.

FIG. 6 is a screenshot of one embodiment of a web application user interface illustrating an example of a state license dashboard with specific tasks and due dates personalized to a specific user.

FIG. 7 is a flowchart illustrating one embodiment of a method for task generation.

FIG. 8A is a flowchart of one embodiment of a method for license/certification renewal and task re-generation as it relates to cyclic tasks.

FIG. 8B is a flowchart illustrating one embodiment of a method for task re-generation as it relates to individually cyclic tasks.

FIG. 8C is a flowchart illustrating one embodiment of a method for task regeneration as it relates to custom cyclic tasks.

FIG. 9 is a flowchart illustrating one embodiment of a method for task-specific due date calculation custom to a user license/certification.

FIG. 10A is a flowchart illustrating one embodiment of the CE content recommendation overview.

FIG. 10B is a continuation of the flowchart of FIG. 10A.

FIG. 11A is a flowchart illustrating one embodiment of a method for generating an applicable course list for a user which may be utilized in making recommendations.

FIG. 11B is a continuation of the flowchart of FIG. 11A.

FIG. 11C is a flowchart illustrating one embodiment of a method for generating specific course recommendations for a task.

FIG. 11D is a flowchart illustrating one embodiment of a method for generating global personalized course recommendations for users.

FIG. 12A is a block diagram illustrating one embodiment of an example of CE content metadata mapping for state relevance to specific tasks based on rules.

FIG. 12B is a block diagram illustrating one embodiment of an example of CE content metadata captured and displayed on a learning center course for state relevance.

FIG. 12C is a block diagram illustrating one embodiment of an example of CE content metadata captured and displayed on a learning center course for course topics.

FIG. 13 is a flowchart illustrating one embodiment of a method for mapping an automated task completion on a user dashboard based on course consumption or course evidence upload by the user.

### DETAILED DESCRIPTION

Reference will now be made in detail to exemplary embodiments of the disclosure, some aspects of which are illustrated in the accompanying drawings.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the claims. Furthermore, there is no intention to be bound by any expressed or implied theory presented in the preceding technical field, background, summary, or the following detailed description.

Reference throughout this specification to “one embodiment,” “an embodiment,” “another embodiment,” or similar language means that a particular feature, structure, or characteristic described in connection with the embodiment is included in at least one embodiment. Thus, appearances of the phrases “in one embodiment,” “in an embodiment,” “in some embodiments,” and similar language throughout this specification may, but do not necessarily, all refer to the same embodiment, but mean “one or more but not necessarily all embodiments” unless expressly specified otherwise.

The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. As used herein, the term “a,” “an,” or “the” means “one or more” unless otherwise specified. The term “or” means “and/or” unless otherwise specified.

As used herein, the term “computing device” may include a desktop computer, a laptop computer, a tablet computer, a mobile device such as a mobile phone or a smart phone, a smartwatch, a gaming console, an application server, a database server, or some other type of computing device. A computing device may include a physical computing device or may include a virtual machine (VM) executing on another computing device. A computing device may include a cloud computing system, a distributed computing system, or another type of multi-device system.

As used herein, the term “data network” may include a local area network (LAN), wide area network (WAN), the Internet, or some other network. A data network may include one or more routers, switches, repeaters, hubs, cables, or other data communication components. A data network may include a wired connection or a wireless connection.

As used herein, the term “computing platform” or “platform” may include a computing environment where a portion of software can execute. A computing platform may include hardware on which the software may execute. The computing platform may include an operating system. The computing platform may include one or more software applications, scripts, functions, or other software. The computing platform may include one or more application programming interfaces (APIs) by which different portions of the software of the platform may communicate with each other or invoke functions. The computing platform may include one or more APIs by which it may communicate with external software applications or by which external software applications may interact with the platform. The computing platform may include a software framework. The computing platform may include one or more VMs. The software platform may include one or more data storages. The software platform may include a client application that executes on an external computing device and that interacts with the platform in a client-server architecture.

As used herein, the terms “determine” or “determining” may include a variety of actions. For example, “determining” may include calculating, computing, processing, deriving, looking up (e.g., looking up in a table, a database or another data structure), ascertaining, or other actions. Also, “determining” may include receiving (e.g., receiving information or data), accessing (e.g., accessing data in a memory, data storage, distributed ledger, or over a network), or other actions. Also, “determining” may include resolving, selecting, choosing, establishing, or other similar actions.

As used herein, the terms “provide” or “providing” may include a variety of actions. For example, “providing” may include generating data, storing data in a location for later retrieval, transmitting data directly to a recipient, transmitting or storing a reference to data, or other actions. “Providing” may also include encoding, decoding, encrypting, decrypting, validating, verifying, or other actions.

As used herein, the term “access,” “accessing”, and other similar terms may include a variety of actions. For example, accessing data may include obtaining the data, examining the data, or retrieving the data. Providing access or providing data access may include providing confidentiality, integrity, or availability regarding the data.

As used herein, the term “message” may include one or more formats for communicating (e.g., transmitting or receiving) information or data. A message may include a machine-readable collection of information such as an Extensible Markup Language (XML) document, fixed-field message, comma-separated message, or another format. A message may, in some implementations, include a signal utilized to transmit one or more representations of information or data.

As used herein, the term “user interface” (also referred to as an interactive user interface, a graphical user interface or a UI), may refer to a computer-provided interface including data fields or other controls for receiving input signals or providing electronic information or for providing information to a user in response to received input signals. A user interface may be implemented, in whole or in part, using technologies such as hyper-text mark-up language (HTML), a programming language, web services, or rich site summary (RSS). In some implementations, a user interface may be included in a stand-alone client software application configured to communicate in accordance with one or more of the aspects described.

As used herein, the term “modify” or “modifying” may include several actions. For example, modifying data may include adding additional data or changing the already-existing data. As used herein, the term “obtain” or “obtaining” may also include several types of action. For example, obtaining data may include receiving data, generating data, designating data as a logical object, or other actions.

As used herein, the term “data object” may include a logical container for data. A data object may include an instance of an object in a software application implemented with an object-oriented programming language. A data object may include data formatted in an electronic data interchange (EDI) format, such as an eXtensible Markup Language (XML) object, a JavaScript Object Notation (JSON) object, or some other EDI-formatted object. A data object may include one or more functions that may manipulate the data of the data object. For example, a data object may include the functions or methods of an object in a software application implemented with an object-oriented programming language.

The present disclosure is directed to systems and methods improving efficiency in continuing education (CE) management. Such systems and methods, in some embodiments, may include systems and methods for the use of a mobile or web platform that may allow users to enter custom license or certification data and, in response, generate a personalized CE rules tracker with CE content recommendations in a single dashboard. As discussed below, in one embodiment, the systems and methods of the present disclosure may provide the capability for improving the efficiency of current CE systems by streamlining and automating the end-to-end CE management process.

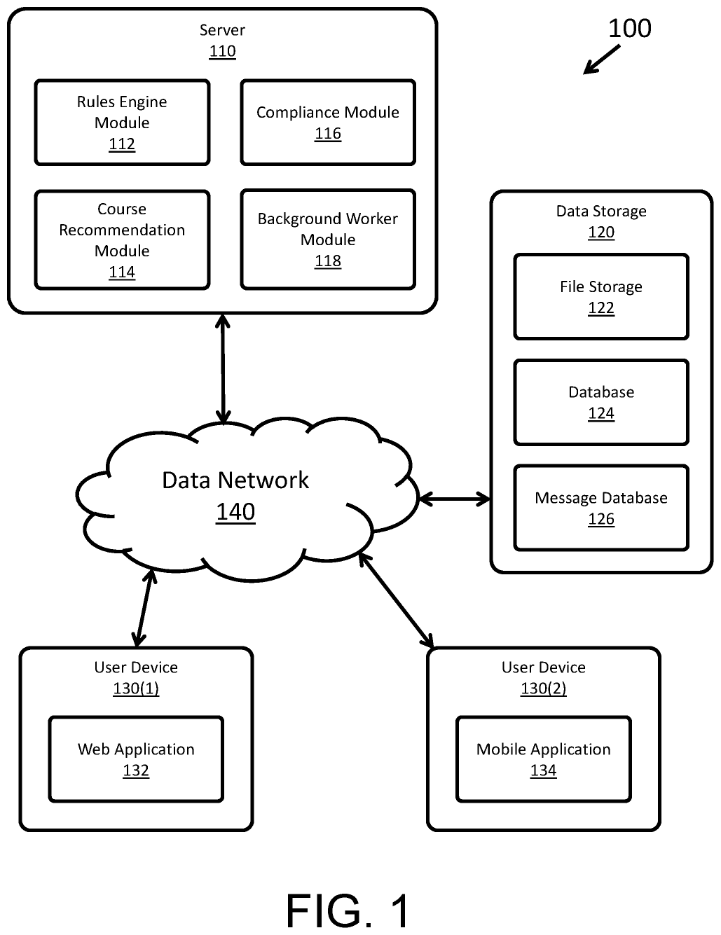

FIG. 1 depicts one embodiment of a system 100. The system 100 may include a system for improving efficiency in CE management. The system 100 may include a sever 100, a data storage 120, or user devices 130(1)-(n). In some embodiments, one or more of these components may include computing device. The server 110 may include a rules engine module 112, a course recommendation engine 114, a compliance module 116, or a background worker module 118. These components 112-118 may include hardware or software modules.

In one embodiment, the data storage 120 may include a file storage 122. The file storage 122 may include one or more logical processes that store files or other data of the system. The file storage 122 may include an Amazon AWS S3 file storage system, a file system, or some other type of file storage. In some embodiments, the data storage 120 may include a database 124. The database 124 may include a relational database, a NoSQL database, a cloud database, an object-oriented database, or some other type of database. The database 124 may include a PostgreSQL database or some other type of database. The data storage 120 may include a message database 126. The message database 126 may include a Redis database or some other type of database.

In one embodiment, the system may include a web application 132 or mobile application 134. The web application 132 or mobile application 134 may be in data communication with the server 110 and may form a client-server architecture. The web application 132 may include an application or functionality that may execute on the user device 130(1), such as a browser. The mobile application 134 may include a mobile application that may execute on the user device 130(2) (e.g., the user device 130(2) may include a mobile phone). The web application 132 or mobile application 134 may each include an interactive application. The web application 132 or mobile application 134 may include Angular or React-Native applications or applications developed using other types of programming technologies.

In one or more embodiments, the server 110 may include the rules engine module 112. The rules engine module 112 may be configured to generate one or more task based on rules and regulations configurations. The server 110 may include a course recommendation module 114. The course recommendation module 114 may be configured to recommend CE courses that help work toward fulfilling one or more tasks generated by the rules engine module 112. The compliance module 116 may be configured to determine if a user is in compliance with the rules and regulations regarding CE. In some embodiments, the background worker module 118 may be configured to perform various operations that support to operations of the other modules 112-116 (e.g., for sending emails or processing algorithms). In some embodiments, these modules 112-118 may include an application code base, a Ruby on Rails application, or an application developed using other types of programming languages.

In some embodiments, the system 100 of FIG. 1 may provide a CE management platform. The platform may include one or more components of the system of FIG. 1. The platform may include a cloud based infrastructure system.

In some embodiments, various components of the system 100 may communicate with each other over a data network 140. In some embodiments, at least a portion of the data storage 120 may be hosted on the server 110. In certain embodiments, certain components of the server 110 may be hosted on different physical computing devices.

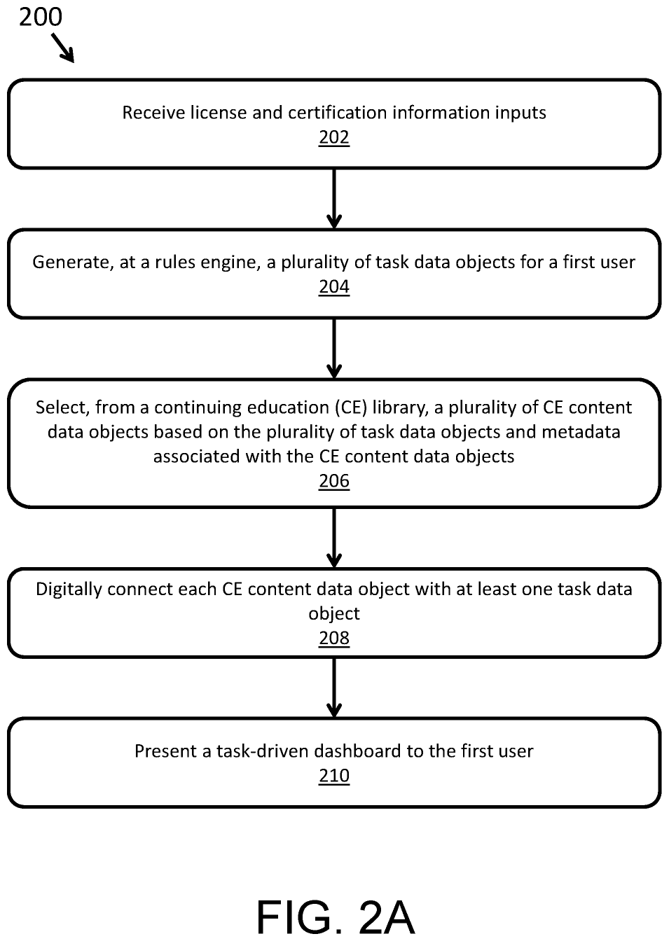

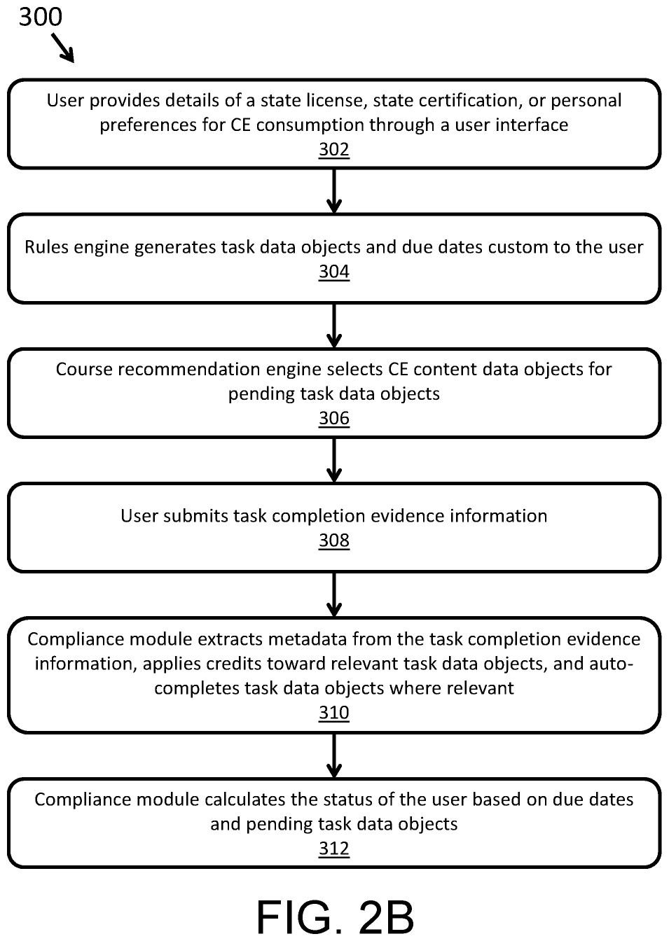

FIG. 2A depicts one embodiment of a method 200. The method 200 may include a method for improving efficiency in CE management. The method 200 may include one embodiment of an end-to-end user flow for interacting with the CE management platform disclosed in this disclosure. The method 200 may include receiving license and certification information inputs (step 202). The method 200 may include generating, at a rules engine module 112, a plurality of task data objects for a user (step 204). The method 200 may include selecting, from a CE library, a plurality of CE content data objects based on the plurality of task data objects and metadata associated with the CE content data objects (step 206). The method 200 may include digitally connecting each CE content data object with at least one task data object (step 208). The method 200 may include presenting a task-driven dashboard to the user (step 210).

FIG. 2B depicts another embodiment of a method 300 that may include a method for improving efficiency in CE management. The method 300 may include another embodiment of an end-to-end user flow for interacting with the CE management platform. The method 300 may include steps that are similar to one or more steps of the method 200 of the FIG. 2A. In one embodiment, the method 300 may include the user providing details, through a user interface, of a state license, state certification, or personal preferences for CE consumption (step 302). This step may be similar to step 202 of the method 200. The method 300 may include using a rules engine 112 to generate one or more task data objects and due dates custom to the user (step 304). This step may be similar to the step 204. The method 300 may include a course recommendation engine 114 selecting one or more CE content data objects that can help fulfill pending task data objects (step 306). This step may be similar to steps 206-210. The method 300 may include the user submitting task completion evidence information (step 308). The method 300 may include a compliance module 116 extracting metadata from the task completion evidence information and applying credits toward relevant task data objects (step 310). The compliance module 116 may also automatically complete task data objects where relevant (e.g., in response to all credits of the task data object being fulfilled). The method 300 may include the compliance module 116 calculating the status of the user based one or more due dates or pending task data objects. The status of the user may include statuses such as in-compliance, compliance at risk, or compliance deficient.

Further details about the steps 202-210 of the method 200 are now disclosed. Receiving the license or certification information in step 202 may include a user entering state license or certification related data (such as a license number, a license expiration date, or other relevant fields/flags such as “holding an active DEA certificate”) into the platform through a user interface (UI) on the CE management platform (for example, via the web application 132 or the mobile application 134 of FIG. 1). The user may include a medical provider that may need to comply with various CE requirements.

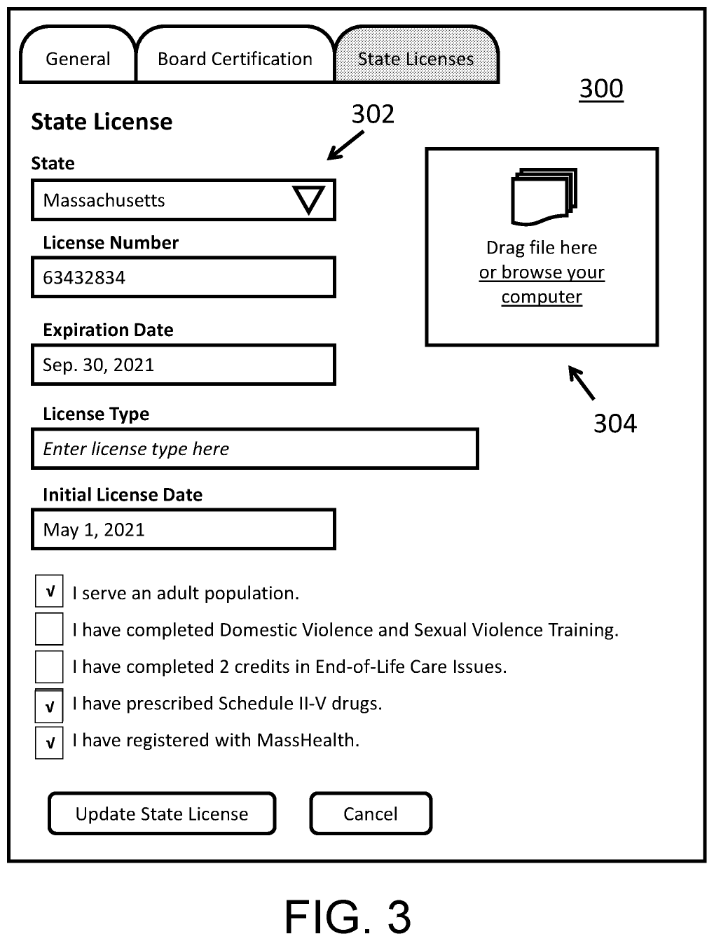

FIG. 3 depicts one embodiment of a UI 300 where a user may enter such license or certification data. The UI 300 may include one or more UI widgets (buttons, text boxes, checkboxes, etc.) where the user may enter the information. The UI 300 may include an area 304 where the user can upload a file to the UI 300 so that the platform can process the uploaded files and determine the license or certification information from the file. For example, the background worker module 118 may process the uploaded files to extract the license or certification information. Such files, information, and other data may be stored in the file storage 122 or the database 124.

In some embodiments, the rules engine module 112 generating the task data objects in step 204 may include the rules engine module 112 initiating a rules-related task generation, which may include creating tasks along with specific due dates custom to the user. In some embodiments, the UI may be displayed on a computing device of a user, and the computing device may be in data communication with the system of FIG. 1.

In one embodiment, a task data object may include a logical container that includes data about a task. The task data object may include various pieces of data relevant to the task and may include logic related to operations or functionality related to the task. In one embodiment, a task data object may include data indicating a due date of the task. The due date may include a single date or a date range. The task data object may include data indicating whether the task is cyclic. Options may include “yes,” “no,” or some other data value. The task data object may include credits data. The credits data may include an amount of credits needed to complete the task, whether the credits are main credits, sub-credits, or stand-alone credits, or some other type of credit. The task data object may include other types of data.

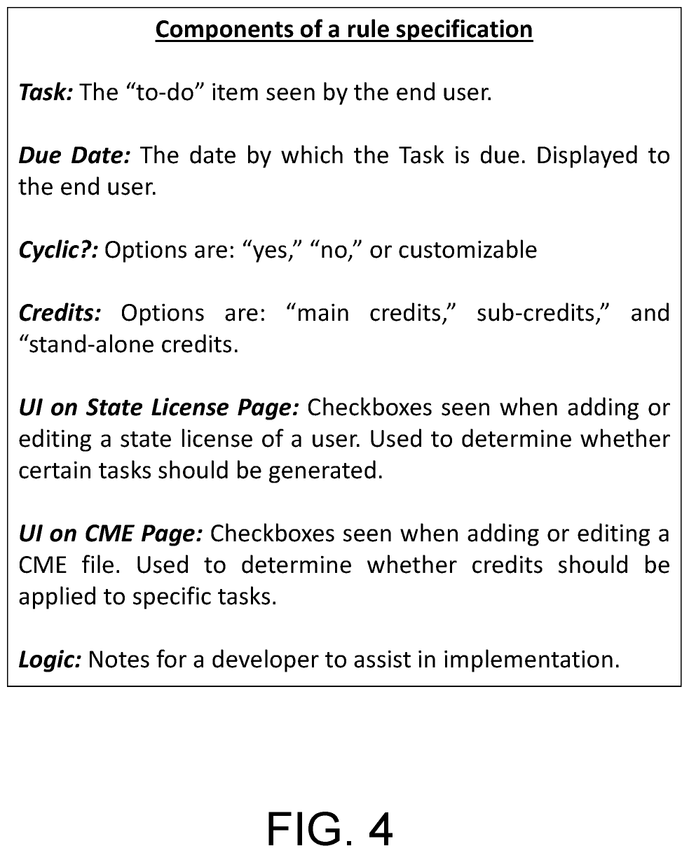

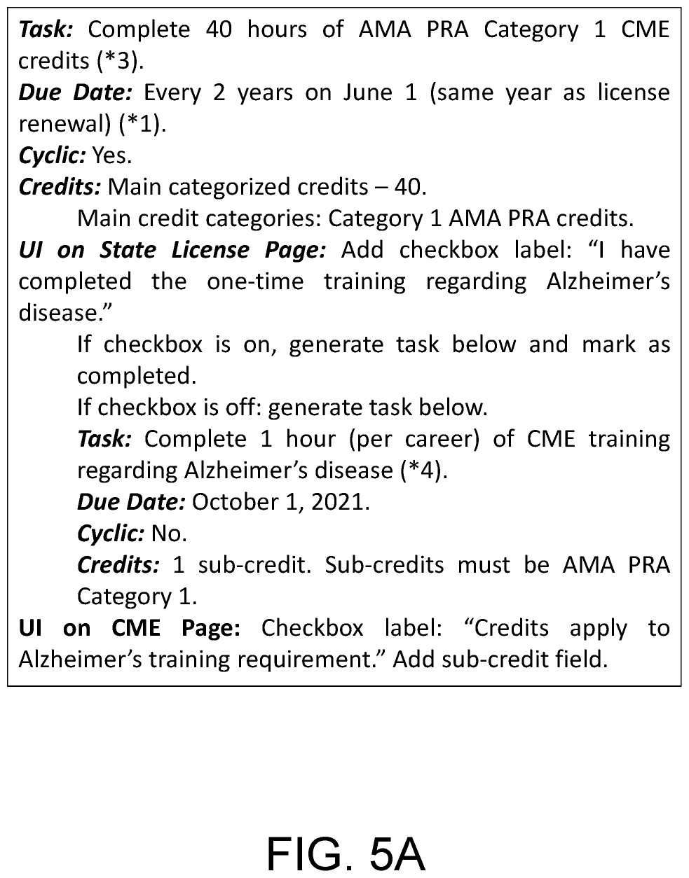

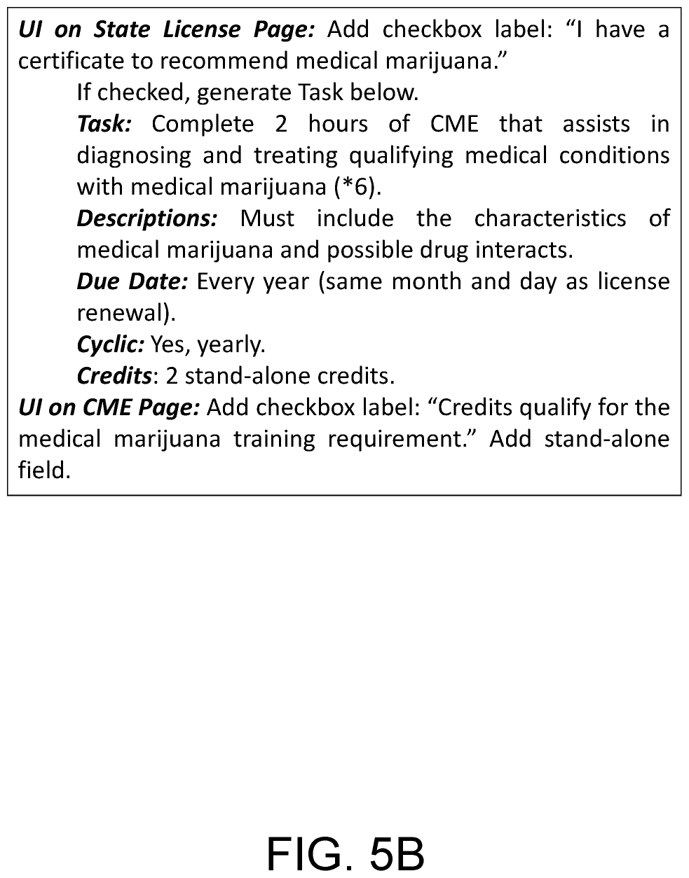

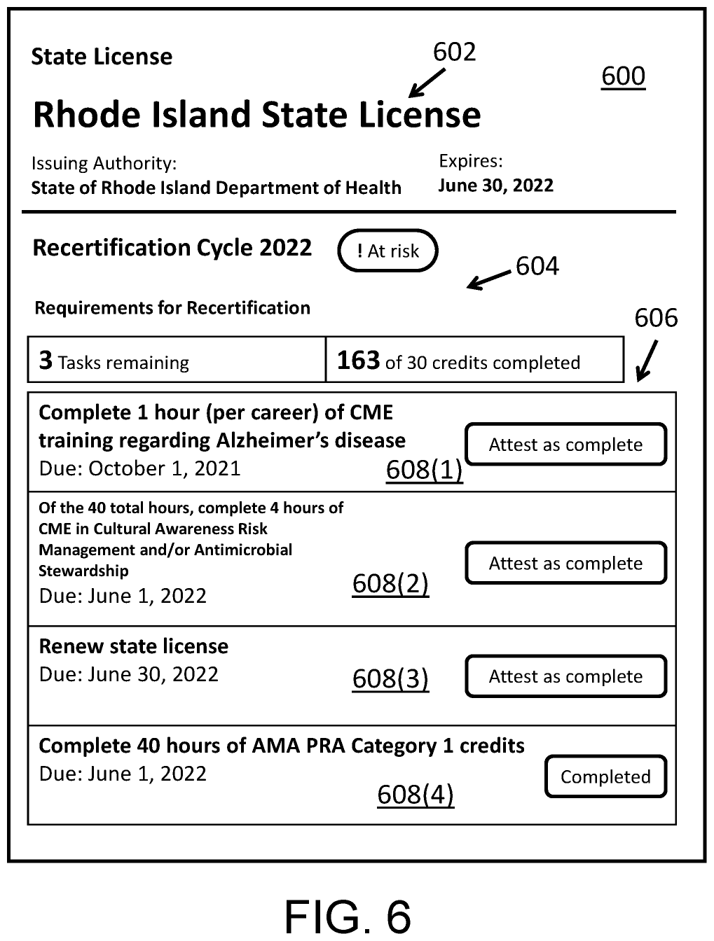

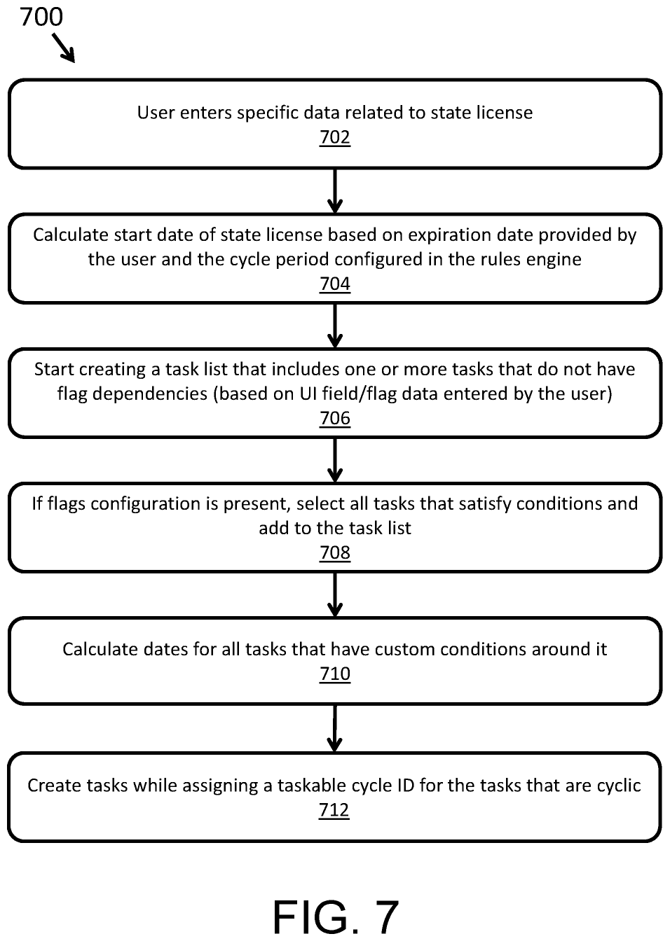

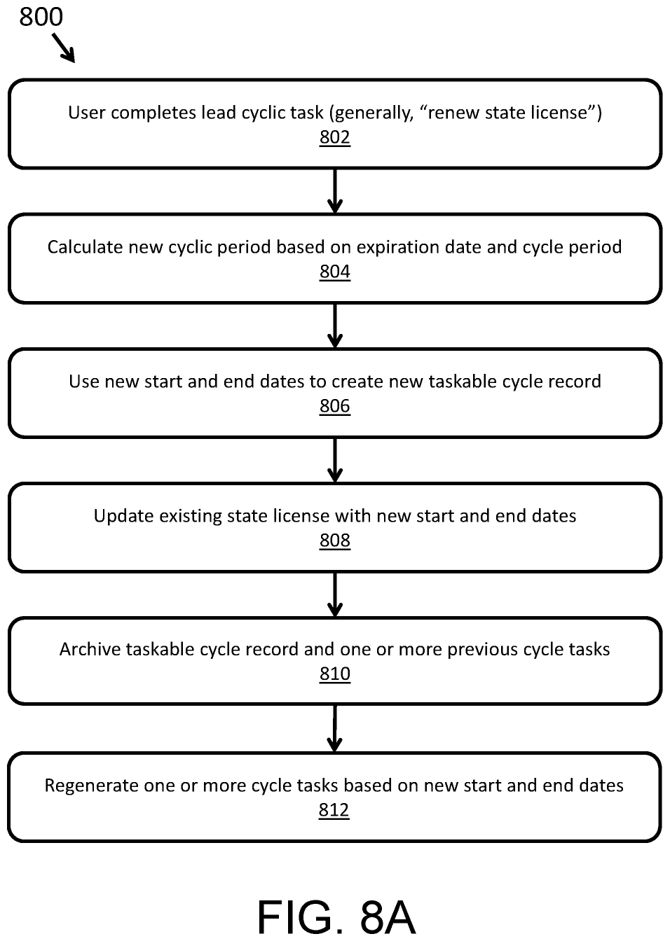

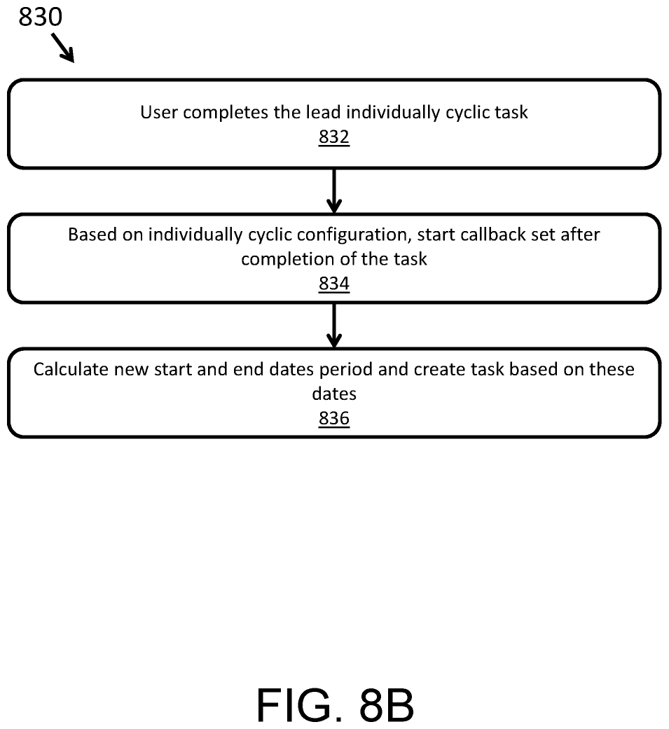

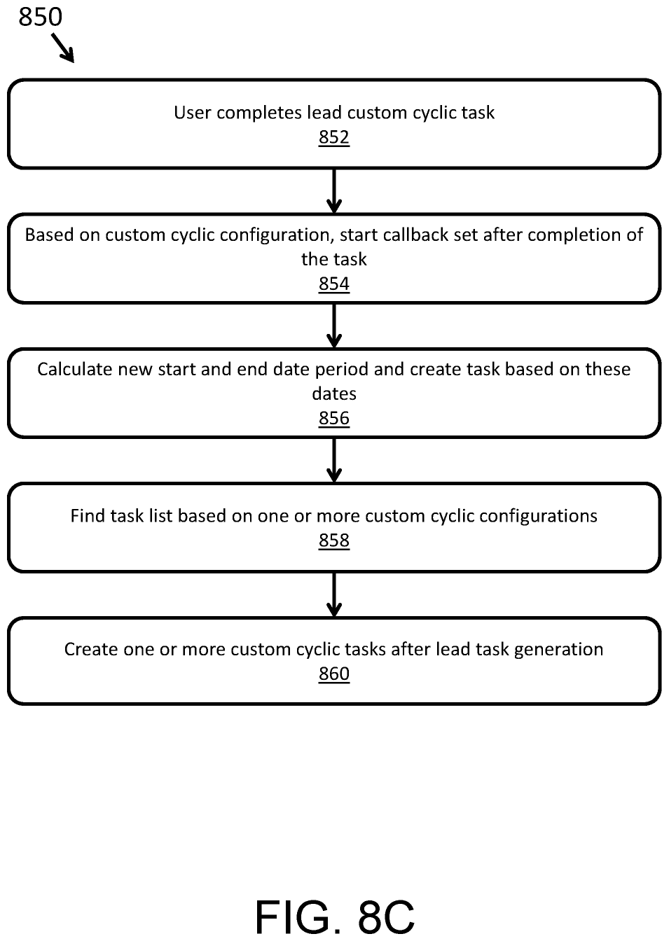

FIG. 4 depicts one embodiment of one or more components of a rule set of the rules engine module 112. In some embodiments, the rules engine module 112 may be built by streamlining a rules and regulation data capture and storage process into a standardized component structure, as illustrated by FIG. 4. The rules engine module 112 may utilize this proprietary data structure and system logic (as illustrated by the methods depicted in FIG. 7, FIG. 8A, FIG. 8B, or FIG. 8C, discussed below) to generate a task-driven user dashboard as exemplified by FIG. 6. A component structure of this first aspect may include the following for a task: name, due date, cyclic nature, credit type and count, UI fields/flags for license onboarding, UI fields/flags for CE categorization, or logic (related to credit calculation or task generation). Some embodiments of the systems and methods of the disclosure may include the “cyclic” and “credit structure” components of a task as discussed below. Below are further descriptions of some embodiments of at least some of the components of FIG. 4 to better explain the rules specification process. FIG. 5A and FIG. 5B illustrate an example of a specified ruleset.
Task: What the user will be prompted to complete in their profile. This may be seen by the end user.
Due date: The date the user needs to complete the task by. This may be user-facing. The system may use the due date or task completion status to determine whether the user is compliant or not.
   Cyclic: Defines whether a task should be generated in future cycles.

The term “cyclic” may denote whether a task should be generated in future cycles after the current cycle is complete. Some possible options for whether a task is cyclic include:
1. Cyclic—The task may cycle with the “Renew License” task
   a. Example: License renewal is every 2 years and the task is due on that same day every 2 years.
   b. Written: “Cyclic: Yes”
2. Individually Cyclic—The task may be generated in future cycles but may be on a different schedule than license renewal.
   a. Example: License renewal is every 2 years, but the task only needs to be done once every 6 years.
   b. Written: “Cyclic: Individually, every ‘X’ years”
3. Custom-Cyclic—The task may be generated based on user input via the license page UI, may be dependent on flags/fields selected/filled by the user and the backend logic based on regulations.
   a. Example: The task needs to be done at every renewal only if a user prescribes controlled substances
4. Non-Cyclic—The task may not be generated in future cycles (used for tasks that may only need to be completed one time).
   a. Example: State has a one-time controlled substance requirement.
   b. Written: “Cyclic: No”
      Credits & Credit Structure: The number of continuing education credits a user must complete to fulfill that task.
This may include a credit structuring system for calculation purposes. Note that the system may include an added layer on top of industry standards for “credit category types” such as American Medical Association PRA Category 1.
The systems and methods, in some embodiments, may include one or more credit structures: main credits, main categorized credits, sub-credits, or standalone credits. These terms may be used internally to capture and calculate how different credit structures may affect each other and how they may relate to the categorization of a CE content evidence file.
   UI on license page: A field, dropdown, checkbox, or selection option that may be shown when inputting/editing a state license or board certification (see FIG. 3). This may be seen by the end user. These options may determine whether the system may generate some tasks based on, at least in part, the logic included with the checkbox.
   UI on CME page: Checkboxes and fields that may be utilized for capturing metadata from evidence files/certificates/transcripts uploaded to the file cabinet of the CE management platform. This information may be viewed (but may not be edited) by the end user. These checkboxes/fields may be used to determine whether the evidence that a user uploads meets the requirements for a task to be associated with that task.

FIG. 5A and FIG. 5B depict an example ruleset. The example ruleset may generate a task to complete 40 hours of AMA PRA Category 1 CME credits. The resulting task may have a due date of every 2 years from June 1st starting on the year the user's license was issued. The resulting task may be cyclic and have 40 main credits of the type Category 1 MAM PRA. The ruleset may generate a checkbox labeled “I have completed the one-time training regarding Alzheimer's disease.” The ruleset may generate the resulting task with logic such that if a user does not check the checkbox, the rules engine module 112 will generate a sub-task with the configuration shown in FIG. 5A. The ruleset may include related CME page functionality. As depicted in FIG. 5B, the ruleset may generate another checkbox, this one labeled “I have a certificate to recommend medical marijuana.” In response to the user checking the checkbox, the ruleset may generate another sub-task with the specified data and functionality.

FIG. 6 depicts an example UI 600 of a task-driven dashboard. The UI 600 may include an identification 602 of the license or certification (e.g., the issuing authority or the expiration date). The UI 600 may include renewal information 604, which may include information such as how many tasks the user has left to complete, the number of credits needed, the number of credits the user has already completed, or other renewal information. The UI 606 may include a list of tasks 606 that the user needs to complete to renew the license or certificate indicated by 602. The list of tasks 606 may include one or more tasks 608(1) that may correspond to task data objects stored by the system 100 for the user. A task 608 may include information such as the name of the task (e.g., “Complete 1 hour (per career) of CME training regarding Alzheimer's disease”), the due date of the task, and a UI widget that allows the user to attest that the user has completed the task. The UI widget may include a button, a file upload that allows the user to upload evidence of completing the task, or some other UI widget. The task list 606 may list completed tasks 606(4) as well as incomplete tasks 606(1)-(3).

FIG. 7 depicts one example embodiment of a method 700 for task generation. In some embodiments, the rules engine module 112 may perform one or more steps of the method 700. The rules engine module 112 may include a complex system of logic that may generate output tasks with specific due dates on the user dashboard 600. The rules engine module 112 may perform the method of FIG. 7 to generate those tasks.

In one embodiment, the user may enter specific data related to state licenses or certifications (step 702). This may include the user entering text information into a UI (such as the UI 300 in FIG. 3), the user uploading a file with the relevant information, or the user may enter the data in some other manner. The rules engine module 112 may initiate the state license task generating flow. This may include the rules engine module 112 calculating a start date of the license or certification based on an expiration date in the data provided by the user (step 704). The rules engine module 112 may calculate a cycle period. The rules engine module 112 may calculate the cycle period based on CE rules and regulation data in the system (e.g., in the database 124 or file storage 122). The rules engine module 112 may create a task list that may include one or more tasks (step 706). A task may include a task that does not include a flag dependence (which may be based on the UI field or flag entered by the user). If a flag is set, the rules engine module 112 may select one or more tasks that satisfy a condition and add those tasks to the task list (step 708). The rules engine module 112 may calculate one or more dates for one or more tasks of the task list that may have custom conditions associated with the tasks (step 710). The rules engine may create the tasks in the task list and may set configuration data for the tasks that indicates that the tasks may be cyclical (step 712).

FIG. 8A depicts one example embodiment of a method 800 for generating a cyclic task. In some embodiments, the rule engine module 112 may perform one or more steps of the method 800. One feature of the customized CE management dashboard may include the handling of the task generation upon a license's or certification's expiration or renewal. The method 800 may regenerate relevant cyclic tasks in response to a user completing a lead cyclic task (e.g., renewing a license/certification) (step 802). A “lead cyclic task” may include a task that is cyclic, (i.e., the user will have to complete the task again at some time in the future) and a task that is a lead task (i.e., the task include sub-tasks, and in response to the user completing the sub-tasks, the user fulfills at least part of the lead task, or in some embodiments, other tasks cannot be completed or even begun until the lead task has been completed). The task-generation logic may be based on the concept of the “cyclic” nature of a task as demonstrated by the differences in task generation logic paths highlighted in FIG. 8A for cyclic tasks vs. the FIG. 8B logic path for individually cyclic tasks and FIG. 8C logic for custom cyclic tasks.

The method 800 may include calculating a new cyclic period based on the expiration date and cycle period (step 804). For example, if the cyclic period is 2 years, and the expiration date is Jun. 1, 2022, then the new cyclic period would be Jun. 2, 2022 through Jun. 1, 2024. The method 800 may include using the new start and end dates to create a new taskable cycle record (step 806). The new start and end dates may include the dates calculated in step 804. The method 800 may include updating the existing license or certification with the new start and end dates (step 808). The method 800 may include archiving the taskable cycle record generating in step 806 and one or more pervious cycle tasks. Such records may be archived in the database 122 or file storage 124. The method 800 may include regenerating one or more cycle tasks based on the new start and end dates. For example, a new task may be added to the list of tasks 606 of the UI 600.

FIG. 8B depicts one embodiment of a method 830 for generating an individually cyclic task. The method 830 may include the user completing the lead individually cyclic task (step 832). An “individually cyclic task” may include a cyclic task whose time period may be longer than the renewal period of the relevant license or certification. For example, a lead individually cyclic task may include completing 200 credits every four years even if the renewal period for the license is every two years. At step 834, the method 800 may include starting a callback after the user has completed the task. A callback may include the rule engine module 114 detecting the completion of the lead individually cyclic task (e.g., by receiving an indication of the completion from the compliance module 116) and then generating subsequent tasks as described in the subsequent steps. The callback may be based on the individually cyclic task's configuration. The method 830 may include calculating a new start date and a new end date and creating a task based on the new start and end dates (step 836).

FIG. 8C depicts one embodiment of a method 850 for generating a custom cyclic task. The method 800 may include the user completing a lead custom cyclic task (step 852), starting a callback after completion of the task (step 854), and calculating a new start date and a new end date and creating a task based on these dates (step 856). These steps 852-856 may be similar to the steps of the method 830 of FIG. 8B. The method 850 may further include the step of finding a task list based on one or more custom cyclic configurations (step 858). In some embodiments, custom cyclic configurations may include configurations that determine a characteristic of the user and gather one or more tasks associated with that characteristics. For example, a customer cyclic configuration may include determining that a user has a certain specialty and gathering one or more tasks related to that specialty. The method 850 may include creating one or more custom cyclic tasks after the lead task has been generated (step 860).

As an example, a custom cyclic configuration may determine, based on user input, (1) that the user is authorized to prescribe or dispense controlled substances in a certain jurisdiction, (2) the date the user received such authorization, and (3) the time period during which the user had such authorization. Based on this customer cyclic configuration, the rules engine module 112 may select the task “Complete X credit hours of board-approved Category I Continuing Medical Education (CME) content relating to pain management or addiction disorders.” The rules engine module 112 may calculate the number of credit hours required to complete the task based on rules logic, such as: (1) if the date the user received the authorization is greater than 2 years from the last day of the CME cycle, 4.5 credits; (2) if the date the user received the authorization is between 1 and 2 years from the last day of the CME cycle, 3 credits; or (3) if the date the user received the authorization is less than 1 year from the last day of the CME cycle, 1.5 credits. The number of credits may be based on the rules logic of the rules engine module 112, which may be based on configurations based on one or more jurisdictions' statutes, rules, mandates, etc.

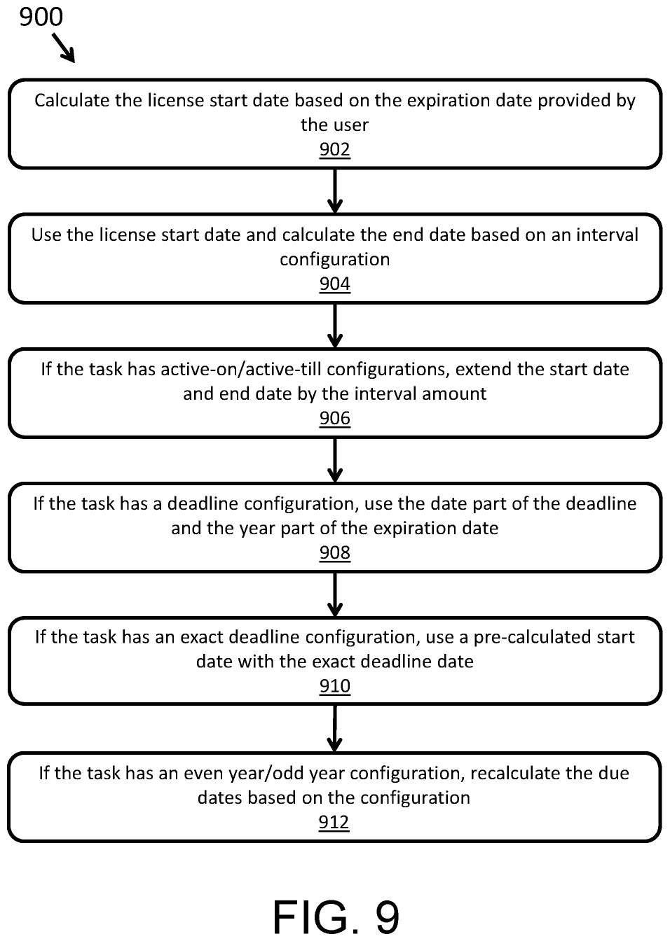

Another element that may differentiate the systems and method of the disclosure from existing CE management systems may include the specific due date attached to one or more tasks. By utilizing one or more of the relevant components of a task (see FIG. 4) available, the rule engine module 112 may generate a user-specific custom due date for each task that may be relevant to a license/certification. FIG. 9 depicts one example of a method 900 generating a task with such a custom due date.

The method 900 may include calculating the license or certification start date based on the expiration date of the license/certification provided by the user (step 902). The method 900 may include using the license start date in calculating the license end date based on an interval configuration (step 904). The rules engine module 112 may obtain the interval configuration from user input, ruleset logic, or some other source. The method 900 may include, if the task has an active-on or active-till configuration, extending the start and end dates by the interval amount (step 906). The active-on configuration may include data indicating that the license/certification begins being active on a specified date, and the active-till configuration may include data indicating that the license/certification expires on a specified date. The method 900 may include, if the task has a deadline configuration, using the date part of the deadline (e.g., the month and the day portion) and the year part of the expiration date (step 908). The method 900 may include, if the task includes an exact deadline configuration, using a pre-calculated start date with the exact deadline as the end date (step 910). The method 900 may include, if the task includes an even/odd year configuration, recalculating the due date(s) based on this configuration. For example, the due date may include every odd year on the date of the expiration of the license. In the case where the user's license expires on June 1, the due date may include Jun. 1, 2021; Jun. 1, 2023, Jun. 1, 2025, etc.

In one embodiment, the system 100 may include course recommendation functionality. The course recommendation module 114 of the sever 110 may perform at least a portion of that course recommendation functionality. In some embodiments, the course recommendation module 114 may generate course recommendations for pending tasks. Some of the pending tasks may include the tasks created as discussed above in relation to the rules engine module 112. The course recommendation module 114 may connect one or more tasks generated on for a user and displayed on the user's dashboard with the CE content library on the system 100 to generate personalized course recommendations to fulfill at least some of these tasks. This may include capturing data about the user's personal preferences for CE content. The personal preferences may include: (1) price—free vs. paid, (2) value—number of credits per price, (3) length of content, (4) content provider, (5) content type (e.g., course, conference, podcast, bundled packages, etc.), or (6) peer review rating. In some embodiments, the steps 206-210 of the method 200 may include the functionality of the course recommendation module 114.

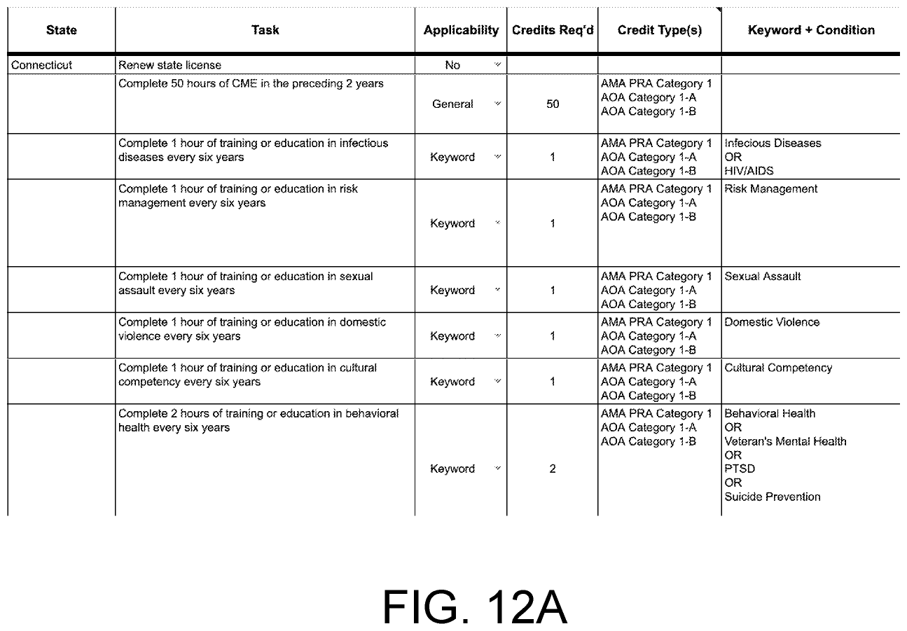

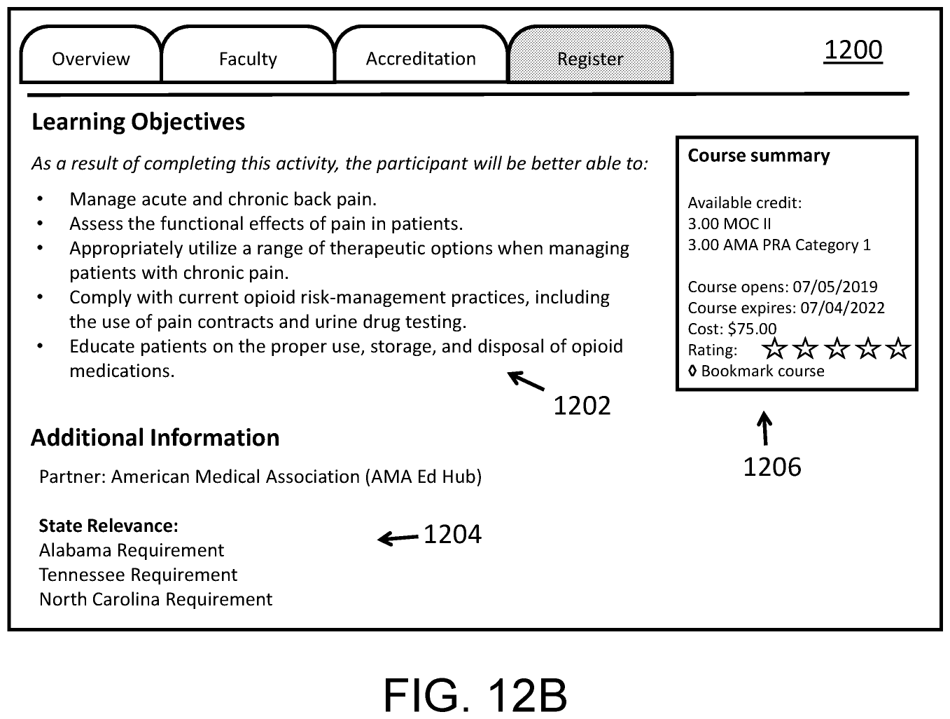

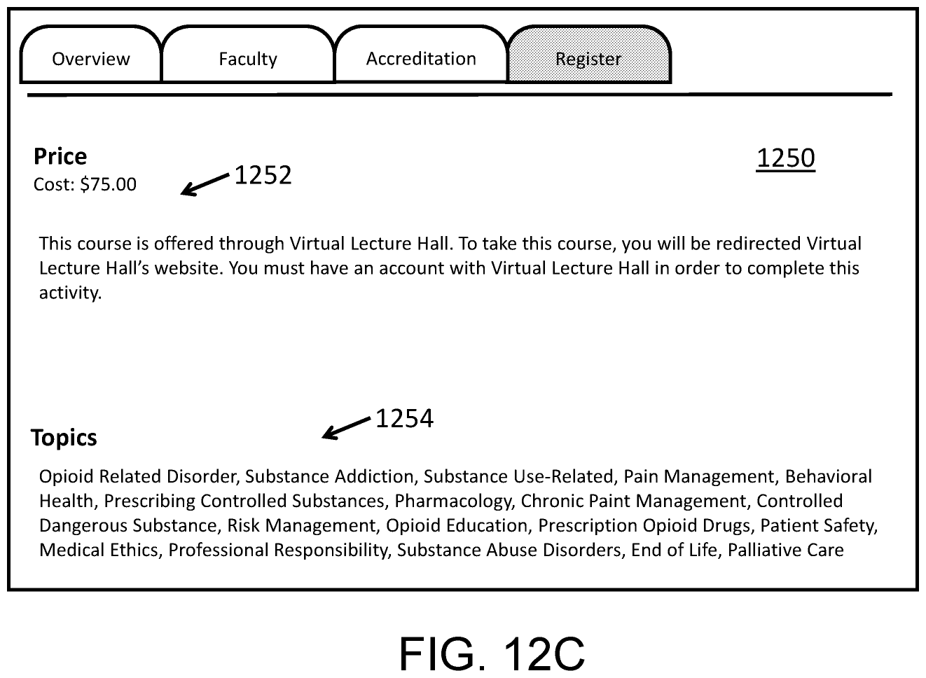

Additionally, the course recommendation module 114 may capture and add a layer of metadata associated with at least some CE content in the library, including, but not limited to, tagging the state rules relevance/mandate information (see FIG. 12B, discussed below) or keywords that may capture course subject matter or topics such as “pain management,” “infection disease,” etc. (see FIG. 12C, discussed below) as illustrated in FIG. 12A, FIG. 12B, or FIG. 12C, discussed below.

In one embodiment, the CE content library discussed herein may include a data structure that includes one or more CE content data objects. A CE content data object may include a logical container for CE content and functionality or features related to such content. A CE content data object may include data indicating a name of the CE content (e.g., the name of a course), how many credits the CE content awards, the types of credit, whether the content is live or on-demand, the format of the content (e.g., an in-person lecture, a video, a text document, etc.), a date available (e.g., the date of the in-person lecture, a date range in which a the video or text document is available), or other data. The CE content data object may include a link to the content of the course associated with the CE content data object (e.g., a link to a video, a link to an external platform where the course is offered, etc.). The CE content data object may include one or more pieces of metadata that may be used by the course recommendation module 114 to search for, sort, or otherwise process the CE content data objects. The CE content library may be stored in the data storage 120 of the system.

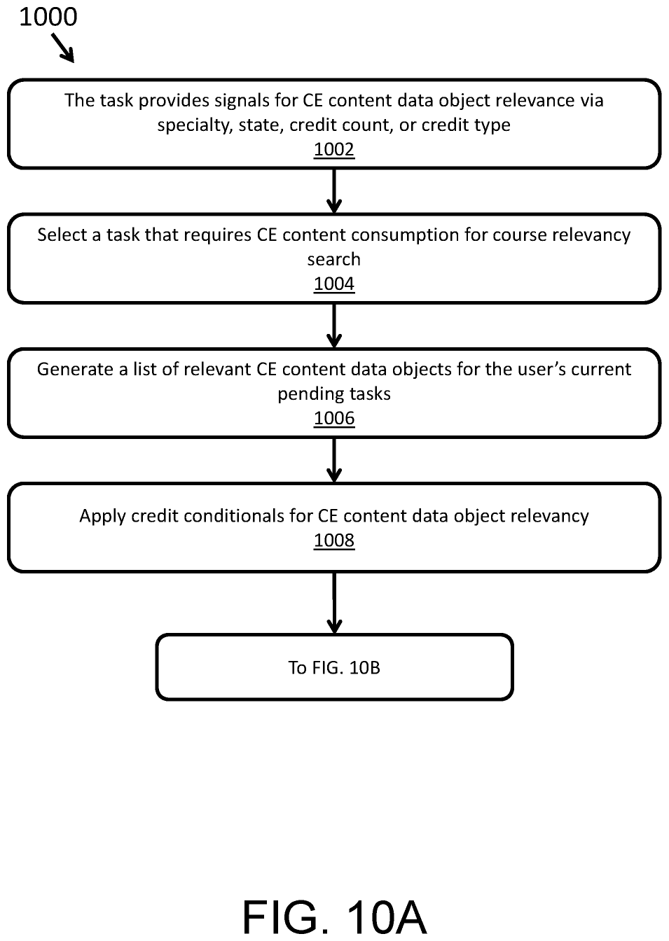

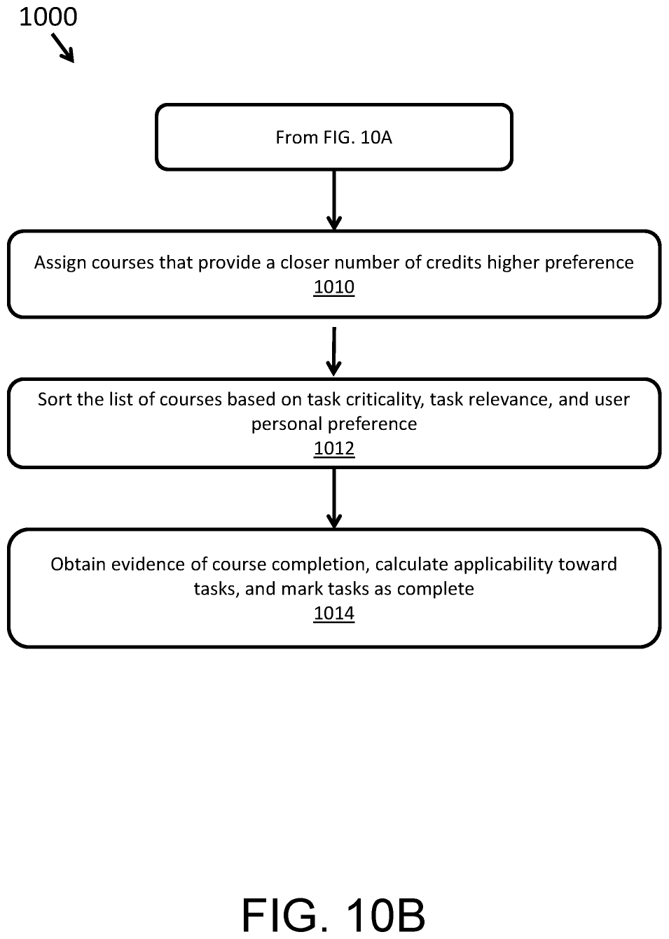

FIG. 10A and FIG. 10B depict one embodiment of a method 1000 for course recommendations. The course recommendation module 114 may perform one or more steps of the method 1000. In one embodiment, task-specific data, course relevancy, or personal preference on CE content may be leveraged to make custom course recommendations to the user by leveraging filtering, sorting and/or ranking techniques. The method 1000 may include the course recommendation module 114 detecting signals or other data from a task generated by the rules engine module 112 (which may be displayed on the user's dashboard) (step 1002). The signals or data may indicate CE content data objects' relevance through specialty, state, credit count, credit type, or other data. The relevance of a CE content data object may indicate the amount by which the course or content associated with the CE content data object is useful to the user in fulfilling one or more tasks. Throughout the processing of the course recommendation module 116, the module 116 may adjust the relevance of a CE content data object as related to the specific user that the module 116 is working on.

The course recommendation module 114 may select a task data object that requires CE content consumption for a course relevancy search (1004). The course recommendation module 114 may generate or compile a list of relevant courses for a user's current pending tasks (step 1006). The course recommendation module 114 may apply credit conditionals (step 1008). Applying credit conditions may include increasing the relevancy of a certain CE content data object due to the data included in the CE content data object (e.g. increasing the relevancy of CE content data objects that have a certain type of credit).

In some embodiments, a task data object from the user's task list may include a certain number of credits in order to complete the task. The course recommendation module 114 may determine which content CE data objects from the list of relevant courses can provide a number of credits that can complete the task (or at least complete a large number of the required credits) and assign such CE content data objects a higher preference (step 1010). In response to the course recommendation module 114 determining the list of relevant CE content data objects, the course recommendation module 114 may sort the CE content data objects based on certain criteria, such as task criticality, task relevance, or user personal preferences (step 1012). The system 100 may then display the sorted list of relevant CE content data objects to the user via a UI. In response to the user completing a course corresponding to a CE content data object, the compliance module 116 may extract metadata from provided evidence data or files and calculate their applicability to the user's tasks in his or her dashboard (step 1014).

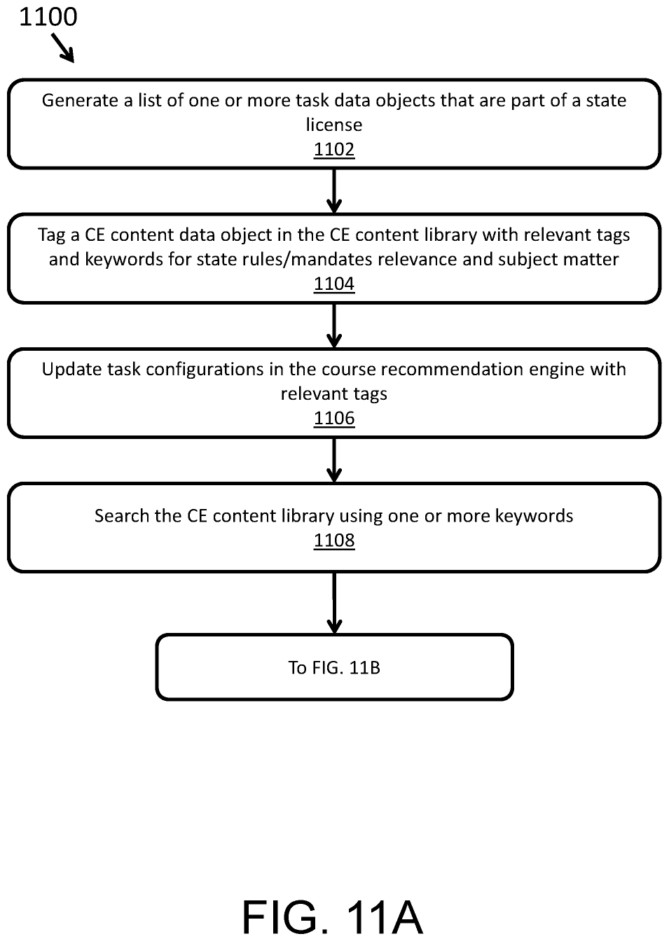

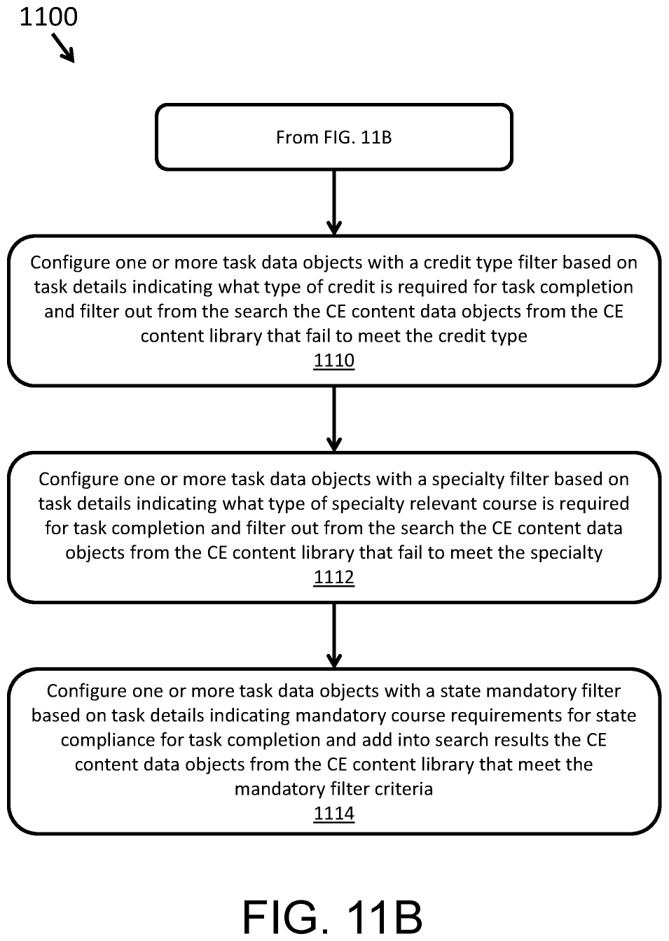

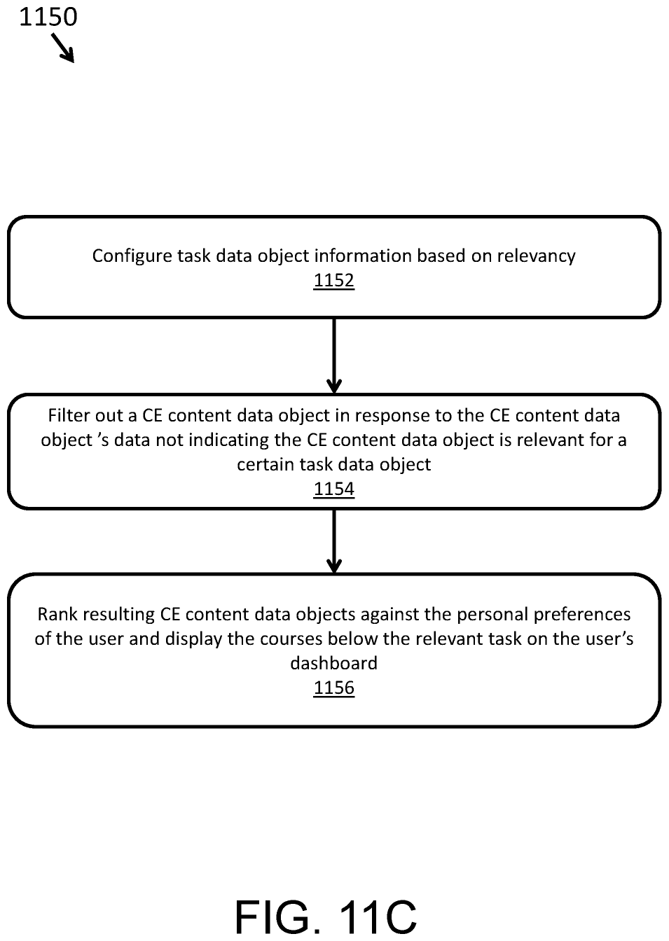

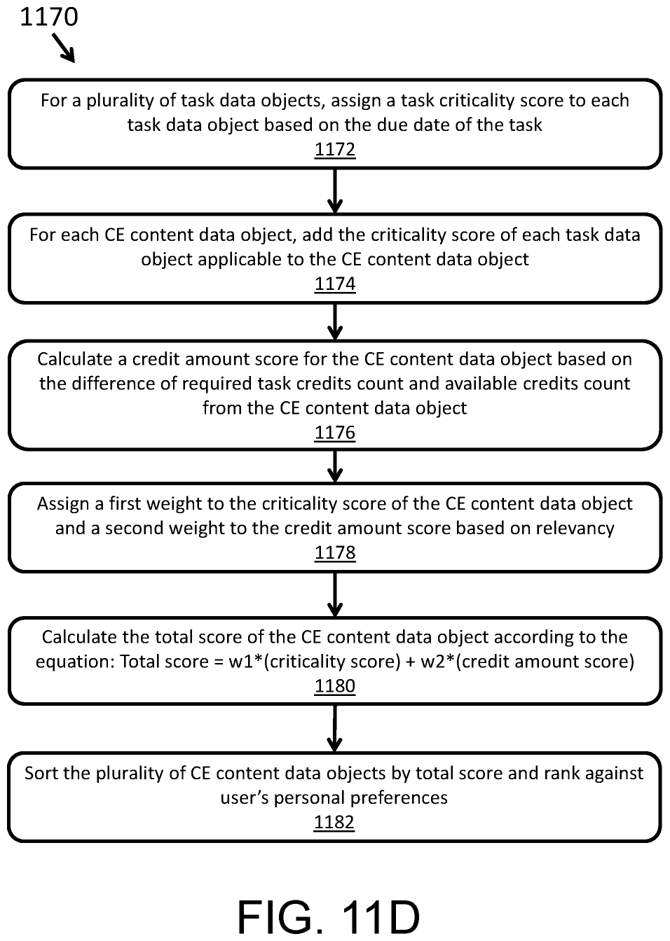

Further details of the logic and criteria used for filtering courses can be found in the example embodiment depicted in FIG. 11A and FIG. 11B, which may map the steps used to generate a list of applicable courses. FIG. 11A and FIG. 11A depict one embodiment of a method 1100 for generating an applicable course list for a user which may be utilized in making recommendations. The course recommendation module 114 may perform one or more steps of the method 1100. The method 1100 may include generating a list of tags for one or more tasks data objects that may be associated with a state license (step 1102). The method 1100 may include tagging one or more CE content data objects in the CE content library with relevant tags or keywords for state rules, relevance, state mandates, or subject matter (step 1104). The method 1100 may include updating one or more task configurations of the course recommendation engine 114 with relevant tags (step 1106). The method 1106 may include searching, for each task data object associated with a state license, for CE content data objects using keywords (step 1108). The searching of step 1108 may include comparing one or more keywords to one or more pieces of data of a CE content data object (e.g., a name, a description, a provider of the CE content, etc.) and selecting the CE content data object as a search result if the comparison indicates the CE content is relevant to the keyword search.

The method 1100 may including filtering selected CE content data objects by credit type or specialty, which may including removing a CE content data object in response to the CE content data object failing to meet a credit type or specialty criteria for a task data object (steps 1110 and 1112). The method 1100 may including adding into the search results CE content data objects based on a task data objects data indicating that the CE content data object is mandatory for state requirements (step 1114). The resulting CE content data objects that comprise the search results may include a CE content data object list that may be used by the course recommendation module 114 to recommend courses to users. Note that the term “courses” is used in a broad sense in FIG. 10, FIG. 11A, FIG. 11B, FIG. 11C, and FIG. 11D and is only an example, thus this logic may apply to any type of CE content.

By tagging CE content data objects in the CE content library with relevant metadata tags based on statutes, rules, regulations, and mandate logic of the rule engine 112 (step 1104), and by updating task configurations with relevant tags (step 1106), as described above, the speed of the search of the CE content library is greatly increased, and fewer computing resources are expended by the server 110 than with conventional searching technology.

FIG. 11C depicts one embodiment of a method 1150. The method 1150 may include a method for ranking courses based on relevancy. The steps of the method 1150 may be in addition to or alternative to one or more of the steps of the method 1100 of FIG. 11A and FIG. 11B. The method 1150 may include configuring task data object information based on relevancy (step 1152). The method 1150 may include filtering out a CE content data object from the search results in response to the CE content data object's data failing to indicate that the CE content data object is relevant to a certain task data object (step 1154). The method 1150 may include ranking the search results against personal preferences inputted by the user and displaying the relevant courses corresponding to the selected CE content data objects below the relevant task on the user's dashboard (step 1156).

In another embodiment of the course recommendation module 114, the specific course recommendations may be listed on the dashboard at the task level. The course recommendations may include a global personalized course recommendation. FIG. 11D depicts one embodiment of a method 1170 for generating a global personalized course recommendation that may be based on functionality or components of the rules engine module 112 or the course recommendation module 114, including tasks, courses, the rules engine, or user preferences. In one embodiment, by looking at not only tasks at an individual license/certification level for a user, but by aggregating relevant task data across at least a portion of the licenses/certifications that the user currently holds, and by gathering one or more relevant CE content that the user could consume, the recommendation engine may determine one or more CE courses/content that may apply to multiple tasks, and the system may present the end user with an efficient path to staying compliant with CE. Thus, in some embodiments, the system may include streamlining and providing an efficient CE management system.

The method 1170 may include, for multiple task data objects, assigning a task criticality score to each task, where the criticality score is based on the due date of the task (step 1172). The criticality score may include a value that indicates how critical it is for the user to complete the task (e.g., a higher value may indicate higher criticality). Tasks with deadlines coming up sooner may have higher criticality scores than tasks whose deadlines are later.

The method 1170 may include, for each CE content data object, adding the criticality score of each task data object that is applicable to the CE content data object (step 1174). A task data object may be applicable to a CE content data object if the completing the CE content data object helps fulfil the task data object. The method 1170 may include calculating a credit amount score for the CE content data object based on the difference of required task credits count and available credits count from the CE content data object (step 1176). For example, if the task data object requires 12 credits to complete, and the CE content data object provides 3 credits, then that difference of require task credits count is 9 (12 minus 3).

The method 1170 may include assigning a first weight (w1) to the criticality score of the CE content data object (calculated in step 1174) and a second weight (w2) to the credit amount score based on relevancy (calculated in step 1176) (step 1178). The method 1170 may include calculating a total score for the CE content data object according to the equation: (total score)=w1*(criticality score)+w2*(credit amount score). The method 1170 may include sorting the multiple CE content data objects by their total scores (step 1182). Step 1182 may include ranking the sorted list against the user's personal preferences.

In some embodiments, the user may complete a task data object by completing a recommend course on the platform, attest to completing the task data object manually, or may upload a CE certificate or transcript as evidence of completing the task. The compliance module 116 may extract metadata from one or more evidence files. An evidence file may include data generated in response to completing a task, attestation data from the user, or an uploaded certificate or transcript. The compliance module 116 may calculate and apply credits toward relevant tasks.

The compliance module 116 may auto-complete a task where relevant. The compliance module 116 may calculate a compliance status of a user based on one or more due dates or one or more pending tasks.

FIG. 12A depicts one embodiment of multiple tasks, their associated applicability, credits required to complete the tasks, the associated credit types, and the associated keywords each task may have been tagged with by the rules engine module 112 or course recommendation module 112. Such tasks may include corresponding task data objects with such data stored in them, and the course recommendation module 114 may use those task data objects to find relevance CE content data objects.

FIG. 12B depicts one embodiment of a course dashboard UI 1200. The UI 1200 may display information about a course that includes a corresponding CE content data object in the system 100. The UI 1200 may include course information 1202, which may include information about the course offered. The UI 1200 may include additional information 1204. The additional information may include information that can be used as metadata in the corresponding CE content data object for searching or compliance purposes as described above. The UI 1200 may include a course summary 1206, which may include various data about the course such credits fulfilled by taking the course, credit type, cost, available date, rating, or other data.

FIG. 12C depicts another embodiment of a course dashboard UI 1250. The UI 1250 may include course information 1252, which may be similar to the course information 1202 of the UI 1200 of FIG. 12B. The course information 1252 may include pricing information or information on how to access the course. The UI 1250 may include one or more topics 1254. The one or more topics 1254 may include information that can be used as metadata in the corresponding CE content data object for searching or compliance purposes as described above.

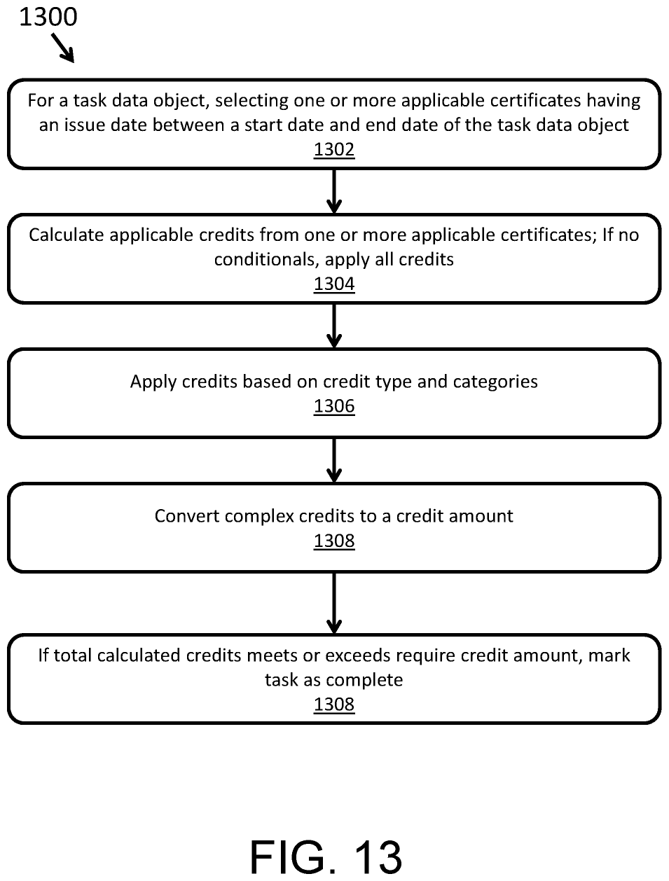

FIG. 13 depicts one embodiment of a method 1300. The method 1300 may include a method for mapping an automated task completion on a user dashboard based on course consumption or course evidence uploaded by the user. In some embodiments, the rules engine module 112, the course recommendation module 114, or the compliance module 116 may perform one or more of the steps of the method 1300. In one embodiment, the method 1300 may provide an automated CE management platform to users, and one or more of the modules 112-116 may automatically complete one or more tasks on the dashboard for the user based on CE evidence uploaded by the user or CE content consumed by the user on the platform. Some of the task components structure described in FIG. 4 may help enable this automatic task completion. Note that the term “certificate” is used only as a narrow example in FIG. 13, and may refer to CE completion evidence files in a broad sense including, but not limited to, transcripts.

The method 1300 may include, for a task data object of the user's dashboard, selecting one or more certificates whose issue date falls between a start date and an end date of the task data object (step 1302). The method 1300 may include calculating applicable credits from the certificate data (step 1304). Calculating the credits may be based on the credit type provided by the certificate. The method 1300 may include applying one or more credits based on the credit type or credit categories (step 1306). For unconditional credits, all of the credits may be applied. For main categorized credits, certain credits may be applied if similar categorized credits are added. For sub-credits, credits associated with relevant sub-credit checkboxes of the task may be applied. The method 1300 may include converting complex credits to a credit amount (step 1308). For stand-alone credits, the credits may be applied in response to relevant checkboxes of the task are selected. For Category 1 type credits, the credits may be applied if the task can accept category 1type credits. If the task includes a completion flag and all required credits for the task are complete, the rules engine module may mark the task as completed (step 1308).

In some embodiments, the background worker module 118 may perform one or more support operations relating to the CE management functionality of the modules 112-116. For example, the background worker module 118 may automatically send out reminder messages to a user. Reminder message templates may be stored in the message database 126, and the background worker module 118 may automatically fill in the user's information into the message template from the database 124. The reminder messages may include emails, short message service (SMS) messages, or other types of messages.

The systems and method disclosed herein improve computing technology and the technical field of computer-based continuing medical education management. Instead of providing (1) static digital content libraries and static webpages that simply present a list of license or certification requirements and (2) simple search functionality that search for CE courses based on tile or description keyword matching, the systems and method disclosed herein provide (1) rules and regulation logic that automatically updates requirement rulesets such that task data objects are automatically updated in response to changes in rules and regulations (2) customizable task data objects that include metadata that improve CE content searching. These improvements form part of steps 204-206 of the method 200. The methods 700, 800, 830, 850, 900, 1000 described herein provide discrete, concrete steps in bringing about these improvements. As such, while computer-based rulesets and computer-based search functionality are known, the systems and methods improve the speed and efficiency of such features.

Furthermore, the CE content data objects also include metadata that improve CE content searching. The systems and methods disclosed herein also provide (1) logic for searching for CE content data objects that fulfill multiple task data objects simultaneously and other relevant search results, and (2) automatic application of compliance evidence to task data objects using extracted metadata These improvements form parts of steps 208-210 of the method 200, and methods 1100, 1150, 1170, and 1300 described herein provide discrete, concrete steps in bringing about these improvements. As such, the invention disclosed herein further improve the speed and efficiency of computer-based search and continuing education management features.

The systems and methods disclosed herein also include unconventional components and unconventional arrangements of components that are not found in conventional systems. For example, rulesets that generate task data objects customized to the user's licenses and certifications are unconventional and improve over static lists of tasks that are generic to all users. The CE content data objects including metadata, credit data, and other searchable data is unconventional and improves over course content that is searchable by keywords only. Finally, the extraction of metadata from task completion evidence computer files is unconventional in the field of computer-based continuing education management. Conventional systems require compliance to be manually checked, decreasing the efficiency of the system overall.

While the making and using of various embodiments of the present disclosure are discussed in detail herein, it should be appreciated that the present disclosure provides many applicable inventive concepts that are embodied in a wide variety of specific contexts. The specific embodiments discussed herein are merely illustrative of specific ways to make and use the disclosure and do not delimit the scope of the disclosure. Those of ordinary skill in the art will recognize numerous equivalents to the specific apparatuses, systems, and methods described herein. Such equivalents are considered to be within the scope of this disclosure and may be covered by the claims.

Furthermore, the described features, structures, or characteristics of the disclosure may be combined in any suitable manner in one or more embodiments. In the description contained herein, numerous specific details are provided, such as examples of programming, software, user selections, hardware, hardware circuits, hardware chips, or the like, to provide understanding of embodiments of the disclosure. One skilled in the relevant art will recognize, however, that the disclosure may be practiced without one or more of the specific details, or with other methods, components, materials, apparatuses, devices, systems, and so forth. In other instances, well-known structures, materials, or operations may not be shown or described in detail to avoid obscuring aspects of the disclosure.

These features and advantages of the embodiments will become more fully apparent from the description and appended claims, or may be learned by the practice of embodiments as set forth herein. As will be appreciated by one skilled in the art, aspects of the present disclosure may be embodied as an apparatus, system, method, computer program product, or the like. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present disclosure may take the form of a computer program product embodied in one or more computer-readable media having program code embodied thereon.

In some embodiments, a module may be implemented as a hardware circuit comprising custom (very large-scale integration) VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer-readable media.

In some embodiments, a module may include a smart contract hosted on a blockchain. The functionality of the smart contract may be executed by a node (or peer) of the blockchain network. One or more inputs to the smart contract may be read or detected from one or more transactions stored on or referenced by the blockchain. The smart contract may output data based on the execution of the smart contract as one or more transactions to the blockchain. A smart contract may implement one or more methods or algorithms described herein.

The computer program product may include a computer-readable storage medium (or media) having computer-readable program instructions thereon for causing a processor to carry out aspects of the present disclosure. The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium may include a portable computer diskette, a random access memory (“RAM”), a read-only memory (“ROM”), an erasable programmable read-only memory (“EPROM” or Flash memory), a static random access memory (“SRAM”), a hard disk drive (“HDD”), a solid state drive, a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present disclosure.

Aspects of the present disclosure are described herein with reference to flowchart illustrations or block diagrams of methods, apparatuses, systems, algorithms, or computer program products according to embodiments of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flow chart diagrams included herein are generally set forth as logical flow chart diagrams. As such, the depicted order and labeled steps are indicative of one embodiment of the presented method. Other steps and methods may be conceived that may be equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A computer-implemented method for improving the efficiency of a continuing education management computer platform, comprising:
receiving, over a data network and from a user interface, license and certification information inputs, wherein the license and certification information inputs include a medical license or certification of a user, and
generating, at a rules engine stored in a computer memory of a server, a plurality of task data objects for the user, wherein each task data object of the plurality of task data objects includes
a name and a due date, and
an amount of credits;
selecting, from a data storage that stores a continuing education (CE) content library, a plurality of CE content data objects based on the plurality of task data objects and metadata associated with the CE content data objects;
digitally connecting each CE content data object of the plurality of CE content data objects with at least one task data object of the plurality of task data objects; and
presenting, via a second user interface, a task-driven dashboard to the user, wherein the dashboard includes a visual representation of
the plurality of task data objects, and
the plurality of the CE content data objects.

2. The method of claim 1, wherein the first user interface comprises the user interface of a web browser executing on a computing device of the user.

3. The method of claim 1, wherein the license and certification information inputs further comprises at least one of:
a license number;
a license expiration date;
a certification number; or
a certification expiration date.

4. The method of claim 1, further comprising receiving, over the data network and from the user interface, user personal preference information.

5. The method of claim 4, wherein selecting the plurality of CE content data objects is further based on the user personal preference information.

6. The method of claim 1, further comprising receiving, over the data network, task completion evidence information.

7. The method of claim 6, wherein the task completion evidence information includes an attestation information from the user.

8. The method of claim 6:
wherein the task completion evidence information includes a file; and
further including
extracting metadata from the file,
calculating a credit amount based on the extracted metadata, and
applying the credit amount to a task data object of the plurality of task data objects.

9. A system for improving the efficiency of a continuing education management computer platform, comprising a non-transitory computer-readable storage medium having executable instructions stored thereon, wherein the executable instructions, when executable by a processor, cause the processor to:
receive, over a data network and from a user interface, license and certification information inputs, wherein the license and certification information inputs include a medical license or certification of a user;
generate, at a rules engine stored in a computer memory of a server, a plurality of task data objects for the user, wherein each task data object of the plurality of task data objects includes
a name and a due date, and
an amount of credits;
select, from a data storage that stores a continuing education (CE) content library, a plurality of CE content data objects based on the plurality of task data objects and metadata associated with the CE content data objects;
digitally connect each CE content data object of the plurality of CE content data objects with at least one task data object of the plurality of task data objects; and
present, via a second user interface, a task-driven dashboard to the user, wherein the dashboard includes a visual representation of
the plurality of task data objects, and
for each task data object in the plurality of task data objects, at least one CE content data object of the plurality of the CE content data objects.

10. The system of claim 9, wherein the license and certification information inputs includes an expiration date associated with the medical license or certification.

11. The system of claim 10, wherein:
a first task data object of the plurality of task data objects includes a lead cyclic task type;
the processor is further configured to
generate a second task data object, wherein the second task data object includes a due date based on the expiration date of the license or certification information and a cycle period.

12. The system of claim 9, wherein a CE content data object of the plurality of CE content data objects includes a credit amount.

13. The system of claim 9, wherein a CE content data object of the plurality of CE content data objects includes a credit type.

14. The system of claim 9, wherein a CE content data object of the plurality of CE content data objects includes a link to a continuing medical education course.

15. The system of claim 9, wherein the metadata of a CE content data object of the plurality of CE content data objects includes metadata indicating course subject matter.

16. A system for improving the efficiency of a continuing education management computer platform, comprising:
a server comprising a rules engine module, a course recommendation module, and a compliance module; and
a data storage module comprising a file storage and a database,
wherein the rules engine module is configured to
receive, over a data network and from a user interface, license and certification information inputs, wherein the license and certification information inputs include a medical license or certification of a user, and
generate a plurality of task data objects for the user, wherein each task data object of the plurality of task data objects includes a name and a due date, and an amount of credits,
wherein the course recommendation module is configured to
select, from the database that stores a continuing education (CE) content library, a plurality of CE content data objects based on the plurality of task data objects and metadata associated with the CE content data objects,
digitally connect each CE content data object of the plurality of CE content data objects with at least one task data object of the plurality of task data objects, and
present, via a second user interface, a task-driven dashboard to the user, wherein the dashboard includes a visual representation of the plurality of task data objects, and the plurality of the CE content data objects, and
wherein the compliance module is configured to
receive a task completion evidence file from the user,
store the file in the file storage,
extract metadata from the file,
calculate a credit amount based on the extracted metadata, and
apply the credit amount to a task data object of the plurality of task data objects.

17. The system of claim 16, wherein the course recommendation module being configured to select the plurality of CE content data objects comprises searching the CE content library using one or more keywords.

18. The system of claim 17, wherein the course recommendation module is further configured to filter out one or more CE content data objects of the plurality of CE content data objects based on the one or more CE content data objects failing to meet a credit type criteria.

19. The system of claim 17, wherein the course recommendation module is further configured to filter out one or more CE content data objects of the plurality of CE content data objects based on the one or more CE content data objects failing to meet a specialty type criteria.

20. The system of claim 16, wherein the course recommendation module being configured to present the task-driven dashboard to the user comprises sorting the plurality of CE content data objects based on a credit amount of each of the CE content data objects.
